(19) United States
(12) Patent Application Publication
(10) Pub. No.: US 2014/0222469 A1
(43) Pub. Date: Aug. 7, 2014

(54) SYSTEM AND METHOD FOR AUTOMATED INTELLIGENT INSURANCE RE-QUOTING

(71) Applicant: KEMPER CORPORATE SERVICES, INC., Chicago, IL (US)

(72) Inventors: Michael Stahl, Jacksonville, FL (US); Marshall Atchison, Havertown, PA (US)

(73) Assignee: KEMPER CORPORATE SERVICES, INC., Chicago, IL (US)

(21) Appl. No.: 13/761,148

(22) Filed: Feb. 6, 2013

(51) Int. Cl. G06Q 40/08

(52) U.S. Cl. CPC G06Q 40/08
USPC 705/4

(57) ABSTRACT

A computer system is configured to perform automated insurance re-quoting operations and perform acts including storing an insurance customer data set and, in association therewith, one or more insurance re-quoting triggers and one or more betterment conditions. The computer system is configured to conduct an insurance re-quoting operation responsive to satisfaction of at least one insurance re-quoting trigger and access, directly or indirectly, at least one insurance carrier quoting system to cause the insurance carrier or carriers to return insurance quote(s), access at least one third-party service to cause the third-party service to return insurance quote(s) or an insurance quote estimate(s). The computer system stores, in association with the insurance customer data set, the returned insurance quote(s) or insurance quote estimate(s) and compares the returned insurance quote(s) and/or insurance quote estimate(s) to determine if the returned insurance quote(s) and/or insurance quote estimate(s) satisfy the betterment condition(s).

Historically, the providing of insurance quotes requires the customer to go through the effort of contacting an insurance provider, an insurance agent or an insurance agency, whether in-person, by telephone, or on-line through an internet website, to provide information necessary to obtain an insurance policy quote based on the information provided.

Although insurance customers and prospective insurance customers are now bombarded with insurance advertising. “Save 13% in 10 minutes or less,” “Customers who switch to us save $200,” etcetera, particularly in television advertising and on-line advertising, the process is still largely unchanged despite enhanced interfaces and advertising models. Following through with the quotation process to discover whether or not there is, in fact, any savings at all, let alone one that is worth the trouble of switching from one insurance provider to another insurance provider, still takes a lot of time and work on the part of the customer or prospective customer (e.g., data entry via website quotation engines, limits on local agent availability, time spent navigating through telephone menus, etc.). This difficulty is compounded if the customer is assessing whether to switch multiple insurance products from one insurance provider to another insurance provider, as a saving achieved in one product may be offset by or exceeded by an increased cost in one or more other products. Customers may also fail to adequately evaluate, or compare, policy coverages, exclusions, or terms (e.g., contract language as in “terms and conditions”).

These difficulties are magnified yet further if the customer is assessing changes for multiple insurance providers and/or assessing changes repeatedly over time on the basis of changes in the customer's life over time. Since rates, offers (e.g., incentives), and life changes (e.g., driving accident status, etc.) can fluctuate over time, and even day-to-day, comparisons must be performed contemporaneously to provide accurate comparisons. If all of the research is not performed contemporaneously, the customer will have to start over to obtain accurate comparisons or will make potentially inaccurate comparisons.

The conventional processes and systems take too much time and are, simply put, a huge hassle.

### BRIEF SUMMARY OF THE INVENTION

In accord with at least some aspects of the present concepts, a computer system is configured to perform automated insurance re-quoting operations and perform acts including storing an insurance customer data set and, in association therewith, one or more insurance re-quoting triggers and one or more betterment conditions. The computer system is configured to conduct an insurance re-quoting operation responsive to satisfaction of at least one insurance re-quoting trigger and access at least one insurance carrier quoting system to cause the insurance carrier or carriers to return insurance quote(s), access at least one third-party service to cause the third-party service to return insurance quote(s) or an insurance quote estimate(s). The computer system stores, in association with the insurance customer data set, the returned insurance quote(s) or insurance quote estimate(s) and compares the returned insurance quote(s) and/or insurance quote estimate(s) to determine if the returned insurance quote(s) and/or insurance quote estimate(s) satisfy the betterment condition(s).

In accord with at least some aspects of the present concepts, a computer system is configured to perform automated insurance re-quoting operations, the computer comprising a communication device, at least one processor, and at least one physical storage medium, the computer system being programmed to execute instructions borne by the at least one physical storage medium to cause the computer system to perform acts comprising storing an insurance customer data set in the at least one physical storage medium, the insurance customer data set comprising data on an existing customer insurance policy and storing in the at least one physical storage medium, in association with the insurance customer data set, one or more insurance re-quoting triggers and one or more betterment conditions. The computer system is further configured to perform an act of conducting an insurance re-quoting operation using the at least one processor and the communication device, responsive to satisfaction of at least one of the one or more insurance re-quoting triggers, the insurance re-quoting operation comprising accessing at least one insurance carrier quoting system to cause the at least one insurance carrier to return an insurance quote. The computer system is further configured to perform acts of storing, in association with the insurance customer data set, the returned insurance quote and comparing, using the at least one processor, the returned insurance quote to the existing customer insurance policy to determine if the returned insurance quote satisfies the one or more betterment conditions.

In accord with another aspect of the present concepts, a computer system is configured to perform automated insurance re-quoting operations, the computer comprising a communication device, at least one processor, and at least one physical storage medium, the computer system being programmed to execute instructions borne by the at least one physical storage medium to cause the computer system to perform acts comprising storing an insurance customer data set in the at least one physical storage medium. The method also includes the act of storing in the at least one physical storage medium, in association with the insurance customer data set, one or more insurance re-quoting triggers and one or more betterment conditions. The method further includes an act of conducting an insurance re-quoting operation using the at least one processor and the communication device, responsive to satisfaction of at least one of the one or more insurance re-quoting triggers, the insurance re-quoting operation comprising accessing at least one insurance carrier quoting system to cause the at least one insurance carrier to return an insurance quote. The method further includes acts of storing, in association with the insurance customer data set, the returned insurance quote and comparing, using the at least one processor, the returned insurance quote to one or more betterment conditions.

A computer system in accord with at least some aspects of the present concepts is configured to perform automated insurance re-quoting operations and performs acts including storing an insurance customer data set including data on an existing customer insurance policy, storing in association with the insurance customer data set, one or more insurance re-quoting triggers and one or more betterment conditions, and conducting an insurance re-quoting operation responsive to satisfaction of at least one of the one or more insurance re-quoting triggers, the insurance re-quoting operation including accessing at least one insurance carrier quoting system, directly or indirectly, to cause the at least one insurance carrier to return an insurance quote. The system is also configured to store the returned insurance quote and to compare the returned insurance quote to the existing customer insurance policy to determine if the returned insurance quote satisfies the one or more betterment conditions.

In accord with at least some aspects of the present concepts, a method for performing automated re-quoting operations, via a processor-based re-quoting computer system including at least one processor, at least one physical storage medium, and a communication device, comprises the acts of storing an insurance customer data set in the at least one physical storage medium, storing in the at least one physical storage medium, in association with the insurance customer data set, one or more insurance re-quoting triggers and one or more betterment conditions, and conducting an insurance re-quoting operation using the at least one processor and the communication device, responsive to satisfaction of at least one of the one or more insurance re-quoting triggers, the insurance re-quoting operation comprising accessing at least one insurance carrier quoting system, directly or indirectly, to cause the at least one insurance carrier to return an insurance quote. The method further includes the acts of storing, in association with the insurance customer data set, the returned insurance quote and comparing, using the at least one processor, the returned insurance quote to the existing customer insurance policy to determine if the returned insurance quote satisfies the one or more betterment conditions.

In accord with at least some aspects of the present concepts, a computer system is configured to perform automated insurance re-quoting operations and performs acts including storing an insurance customer data set in a physical storage medium and storing, in association with the insurance customer data set, one or more insurance re-quoting triggers, at least one of the one or more insurance re-quoting triggers comprising a temporal insurance re-quoting trigger. The computer system is also configured to automatically conduct an insurance re-quoting operation responsive to satisfaction of one of the insurance re-quoting triggers, the re-quoting operation comprising a plurality of iterations of accessing a plurality of insurance carrier quoting systems, directly or indirectly, and transmit the insurance customer data set to the insurance carrier quoting systems to cause insurance carriers relating to the insurance carrier quoting systems to return an insurance quote and to store, in association with the insurance customer data set, the returned insurance quotes.

In accord with another aspect of the present concepts, a method for performing automated re-quoting operations, via a processor-based re-quoting computer system, comprises the acts of storing in a physical storage media of the processor-based re-quoting computer system, first insurance policy data for a first insurance carrier from an insurance customer data set, the first insurance policy being associated with a first cost over a term of the first insurance policy, and receiving input of one or more betterment conditions and one or more insurance re-quoting triggers. The method also includes the acts of transmitting the insurance customer data set to a second insurance carrier, via a communication device, responsive to at least one of the insurance re-quoting triggers to obtain a second insurance quote for a second insurance policy and transmitting the insurance customer data set to a third insurance carrier, via the communication device, responsive to at least one of the insurance re-quoting triggers, to obtain a third insurance quote for a third insurance policy. The method also includes the acts of comparing, using at least one processor, the second insurance quote and third insurance quote to the at least one betterment condition to determine if either of or both of the second insurance quote or third insurance result in a net betterment.

The above summary of the present concepts is not intended to represent each embodiment, or every aspect, of the present concepts. The detailed description and figures will describe many of the embodiments and aspects of the present concepts.

### BRIEF DESCRIPTION OF THE DRAWINGS

The following drawings are provided to illustrate various aspects of the concepts detailed herein, wherein:

FIG. 1 shows a flowchart for a method for performing automated re-quoting in accord with at least some aspects of the present concepts.

FIG. 2 shows a flowchart for another method for performing automated re-quoting in accord with at least some aspects of the present concepts.

FIG. 3 shows an example of a computer system on which the present concepts may be implemented.

FIG. 4 shows a representation of an automated re-quoting in accord with at least some aspects of the present concepts.

FIG. 5 shows an example of a betterment determination, in accord with at least some aspects of the present concepts, for a customer having an existing auto and home policy with insurance carrier A.

While the present concepts are susceptible to various modifications and alternative forms, specific embodiments have been shown by way of example in the drawings and will be described in detail herein. It should be understood, however, that the present concepts are not intended to be limited to the particular forms disclosed, but are intended to include all modifications, equivalents, and alternatives falling within the spirit and scope of the present concepts disclosed herein and defined by the appended claims.

### DETAILED DESCRIPTION OF THE INVENTION

Automated re-quoting, and particularly automated intelligent re-quoting, has been determined by the present inventors to be useful in providing insurance customers with previously unrealizable opportunity for benefits and/or savings. The present concepts described herein automate one or more aspects of insurance re-quoting to thereby actively facilitate communication of one or more potential improvements to a customer. These improvements are not necessarily monetary (i.e., a cost savings), but can include, for example, a higher coverage level, a lower deductible, or simply better claim service for the customer. The concepts herein applied to any insurance product, including but not limited to insurance policies on boats, motorcycles, homes, automobiles, other vehicles, and life, etcetera, and still further to include additional types of insurance such as, but not limited to, health, disability and long-term care.

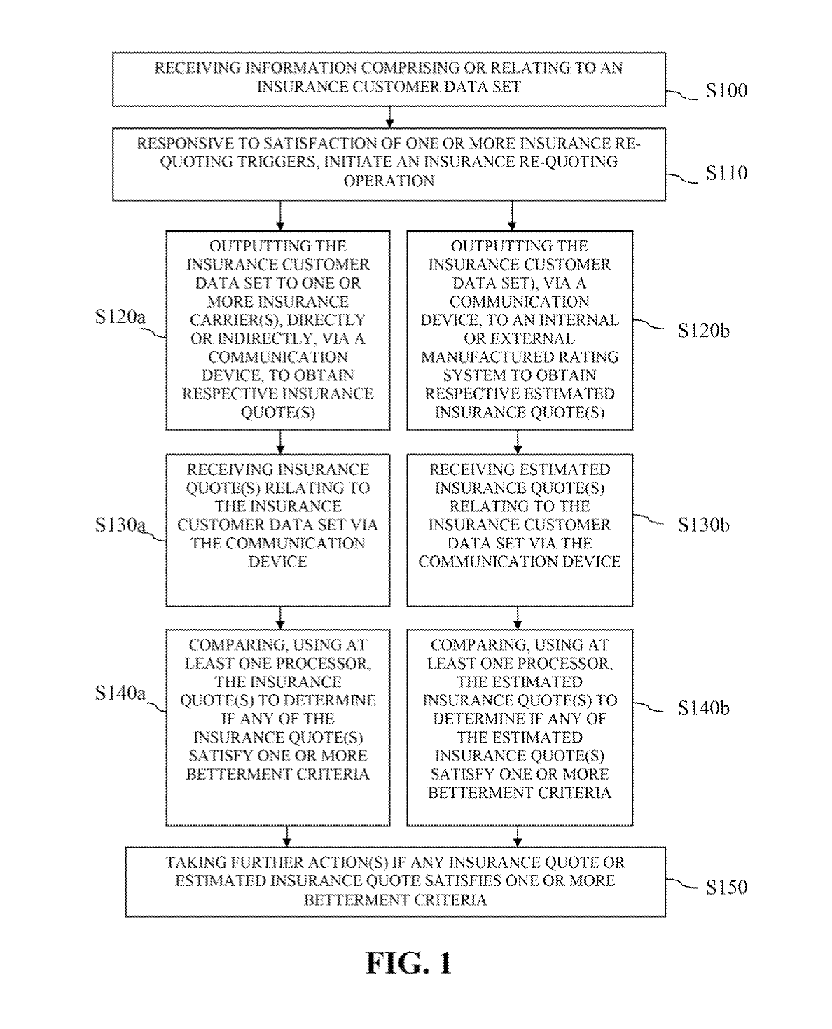

FIG. 1 shows an example of one method for performing automated re-quoting operations, via a processor-based re-quoting computer system or re-quoting engine, in accord with at least some aspects of the present concepts. Act S100 comprises receiving information comprising or relating to an insurance customer data set. This act may include, for example, receiving direct entry of an insurance customer data set (e.g., by a customer) or subset thereof (e.g., one or more specific customer data items) or receiving data from another source or sources which, in the aggregate, comprises an insurance customer data set or a subset thereof.

In at least some aspects, the insurance customer data set or insurance data profile contains sufficient information regarding a person and/or covered risks to permit underwriting and/or pricing of at least one insurance product for at least one insurance carrier. The insurance customer data set contains, in some aspects, relevant insurance information for a person including underwriting and/or pricing information regarding the customer and their insurable assets. Relevant insurance information in the insurance customer data set may include such items as accident history, credit score, cars owned, property information, birthdate, address, loss history, etc. The insurance customer data set may further include information on current and prior insurance policies (e.g., coverage amounts, deductibles, premium, billing plan, features (accident forgiveness, for example), discounts and discount amounts, etc.). The insurance customer data set is optionally, but advantageously, maintained up-to-date in accord with the present concepts so that it is accurate at any given point in time. In at least some aspects of the present concepts, the maintenance of the insurance customer data set incorporates data from one or more 3^{rd} party providers (e.g., firms such as Acxiom or LexusNexus, government entities, web-crawlers, etc.) indicative of insurance customer data changes (e.g., the customer buys a new car or gets into an accident), customer input and/or verification, and data fed from carriers. Also, data relating to the insurance customer may input by, or supplemented by, a third party, or may be derived from customer web activity or customer data entry on a website.

In one aspect, act S100 is conducted by an insurance re-quoting provider, defined herein as any entity that performs an insurance re-quoting operation or insurance re-quoting operations. By way of example, an insurance re-quoting provider maintains an insurance customer data set (e.g., personal information, risk information, etc.) and transmits that data set to one or more 3^{rd} parties (e.g., insurance carriers, external manufactured rating system, web aggregator, etc.) responsive to satisfaction of one or more insurance re-quoting triggers. The one or more 3^{rd} parties return insurance quote information (e.g., a rate, policy terms, etc.) to the insurance re-quoting provider. The insurance re-quoting provider advantageously stores the insurance customer data set and updates and monitors the market on behalf of the insurance customer, triggering re-quoting operations to one or more entered, obtained, and/or derived insurance re-quoting triggers.

The insurance customer data set can include any data relating to the customer obtained from any source that is utilizable in obtaining a quote for a new policy or amended policy, or for satisfying queries for underwriting such policy quote or policy. By way of example, the insurance customer data set is entered by a customer, or potential customer, via an input device such as a key pad, keyboard, microphone, or graphical user interface (“GUI”) of a computer, cellular phone, or other electronic device. The insurance customer data set includes, for example, information necessary to obtain a quote for a new policy or amended policy, or for satisfying queries for underwriting such policy quote or policy. The set of data required for a quote for a new policy or amended policy is itself dependent upon the type of policy.

In operation, where data is input by a customer, for example, using a GUI as noted above for data entry, questions and/or selectable elements are presented that enable the customer to enter insurance customer data appropriate for the type of insurance sought. The insurance customer data for a property or home insurance quote or policy may include, for example, applicant's first name, middle initial, last name, social security number (SS), date of birth (DOB), gender, marital status, co-applicant's information (SS, DOB, etc.), a “rating state,” a property address, years of residency at the property address (street address, city, state, zip code). The insurance customer data for a vehicle insurance quote or policy may include, for example, a vehicle make, model, and year, a vehicle condition, optional vehicle equipment (e.g., safety equipment, alarm, etc.), a customer's driving record, address at which vehicle is to be garaged, distance to be driven over one or more specified periods (e.g., per day, per year, etc.), and number of drivers, a policy effective date. Still additional insurance customer data may comprise, without limitation, impediments to underwriting (e.g., unfenced pool, a tenant occupied dwelling, a loss claimed in the previous 3 years, etc.), a level of liability coverage, a deductible, information on prior loses or claims, a policy term (e.g., annual, semi-annual, quarterly, monthly, weekly, hourly, etc.), other policies issued by the insurance carrier for the customer, a selected payment plan (e.g., weekly, bi-weekly, monthly, quarterly, in-full, etc.), property construction information (e.g., structure type, roof type, construction type, protection class, year built, appraised value of property, number of rooms, and value/price per square foot, etc.). Further, the insurance customer data for other types of insurance policies may include additional information not mentioned in the examples above.

The insurance customer data set used to generate a customer insurance policy for a specified form of insurance may also include, in whole or in part, derived information or 3^{rd} party information (i.e., information that relates to a customer or person, but is not directly input by such customer or person), such as market activity for a group similar to the customer in one or more aspects (e.g., a likeness characteristic derived from multi-dimensional scaling statistical methods and tools such as discriminant analysis, cluster analysis and/or neural networks, a rating of other similarly situated risk class members, etc.), or a customer's past selections (e.g., a customer's history of selections such as options passed on or actions taken), etcetera. The noted 3^{rd} party information may include, for example, information from family members or social media, MLS data (e.g., data relating to a customer's putting of their house up for sale), a record of a customer service issue, a customer's accident (e.g., past a 3 year threshold), etcetera.

The aforementioned method also includes an act S110 of satisfying one or more insurance re-quoting trigger(s), causing initiation of an insurance re-quoting operation. In essence, act S110 determines when to go and get new insurance quotes for a customer. Further optional acts may define insurance re-quoting parameters which define parameters by which the insurance re-quoting operation is conducted such as, but not limited to, defining which insurance carriers are to be included in the insurance re-quoting operation or which insurance product or products are to be included in the insurance re-quoting operation.

Insurance re-quoting triggers can comprise, for example, triggers based on market changes (with an attendant potential to benefit a customer), triggers based on customer changes, temporal triggers, and/or manual triggers. Event-based triggers can comprise, but are not limited to, market changes (e.g., changes of rate, changes of coverages, changes of policy terms; changes in financial strength or solvency of an insurance carrier, changes assessed by evaluating customer populations; and other carrier changes, etc.) or changes with respect to a customer.

To illustrate the first category, assessing whether the market has changed, an insurance re-quoting provider can look at the product/rate filings that carriers submit with departments of insurance (DOI). Absent an insurance carrier's product/price change, which would be triggered by a product/rate filing, it is generally not useful to check the insurance carrier's rates/product. Thus, “market change” insurance re-quoting trigger may be configured to only initiate an insurance re-quoting operation if an insurance carrier filed a rate decrease or, alternatively, a rate decrease specific to some of a customer's characteristics (e.g., territory, age, vehicle types, etc.). The insurance re-quoting provider can also assess “market changes” such as an insurance carrier's rate changes via a manufactured rating system or by watching insurance quotes coming from all sorts of participants and comparing the customer to similarly-situated customers (people like the customer), as discussed elsewhere herein. Further, “market changes” also includes the customer's existing insurance carrier and changes to that (current) insurance carrier's product/rate (i.e., the customer's current policy). Thus, changes relating to a customer's own insurance carrier may be used to trigger an insurance re-quoting operation.

“Customer change” insurance re-quoting trigger may be configured to initiate an insurance re-quoting operation if the customer's life has changed (e.g., as an accident falling off their record, buying a new car, having a 16-year-old join the policy, etc.). Any relevant life event can be used to trigger a re-quoting operation to assess whether a different policy/price/coverage/carrier combination is better for the customer relative to their current policy(s). Life events are assessed when the consumer's data profile changes and whether those changes are relevant to considering whether to obtain new quotes.

An example of an insurance re-quoting trigger includes, by way of example, a temporal trigger, such as a period of time or date and/or time following which the system is to conduct one or more re-quoting operations, such as to seek out competing insurance rates, features, offerings, and/or service(s). Non-limiting examples of such temporal insurance re-quoting trigger(s) include one or more hours, days, weeks, months or years, or fractions thereof, and may optionally, or additionally, include specified dates (e.g., birthday, anniversary of accident, renewal or upcoming renewal, etc.). Although used herein, such period of time does not necessarily require a particular cycle or periodicity, but generically denotes one or more times at which insurance re-quoting is to be triggered. Such a period of time could even comprise a randomly-determined time period (e.g., one or more randomly-selected dates selected within a window of one or more permissible dates). Such an insurance re-quoting trigger could, of course, comprise a single specified period having a predetermined cycle and/or could comprise one or more specific dates at which time insurance re-quoting operations would commence (i.e., no “period” per se). The insurance re-quoting trigger could comprise, in at least one aspect, one or more specific dates in combination with a fixed insurance re-quoting period (e.g., every month). Thus, a temporal re-quoting trigger in accord with the present concepts includes any date, time, period, lapse of time, or the like, or combination thereof in any combination, without limitation.

Any trigger may be used in accord with the present concepts to initiate a re-quoting operation. As one example, a customer can simply access their insurance customer data set, or a prospective customer can input data utilizable in obtaining a quote for a new policy, and such customer or prospective customer could manually trigger an insurance re-quoting operation (or an initial quoting operation in the case of a prospective customer). As another example, a customer may manually trigger a re-quoting operation by just clicking a button or link (e.g., a “go” button) in an email, a web application or other media link without specifically accessing the insurance customer dataset behind the application used for the quoting. As yet another example, an insurance re-quoting trigger may include a non-temporal variable such as, but not limited to, a mileage of an automobile (or other vehicle) for an automobile (or other vehicle) insurance policy (e.g., check every 500 miles, 1000 miles, service appointment, etc.). As a further example, an insurance quoting trigger may utilize data from a GPS device in the vehicle of a customer, with certain patterns of driving and/or vehicle location being used, for example, to trigger an insurance re-quoting operation. Such non-temporal alternative insurance re-quoting triggers may complement or supplement the aforementioned temporal insurance re-quoting triggers.

In yet further examples, the insurance re-quoting trigger may comprise a randomized variable or may be randomly or pseudo-randomly performed. For example, where an insurance re-quoting trigger is a non-temporal variable such as automobile mileage, the insurance re-quoting trigger may comprise a pure random value or a random value selected between a set or randomly determined upper and lower limit (e.g., a lower and upper mileage). As another example, the insurance re-quoting trigger may comprise a random temporal trigger.

Another insurance re-quoting trigger in accord with the present concepts includes a functional trigger or a combination trigger wherein a plurality of conditions or variables must be satisfied (e.g., simultaneously, in series, collectively, etc.). By way of example, variable A and variable B must both be satisfied, in any order, to trigger an insurance re-quoting operation.

Thus, insurance re-quoting operations in accord with the present concepts are triggered or initiated by one or more insurance re-quoting triggers, which may be entered by any person, computer system or service, or entity, and which may comprise actual data, derived data, estimated data and/or assumed data. By way of example, a customer of an insurance re-quoting provider can enter one or more desired insurance re-quoting triggers, or to modify previously entered insurance re-quoting triggers, using a GUI or other input device (e.g., computer keyboard, cell phone keyboard, voice command using a microphone, etc.). As another example, one or more desired insurance re-quoting triggers may be input by an insurance re-quoting provider in association with its customer. With respect that the use of derived data to form an insurance re-quoting trigger, or a part of an insurance re-quoting trigger where the insurance re-quoting trigger is a functional combination of a plurality of conditions, the derived data may comprise data derived by an artificial intelligence engine or neural network configured to make intelligent or adaptive decisions from customer-related data or group-related data wherein the group is related to the customer with respect to one or more characteristics.

Likewise, one or more insurance re-quoting parameters in accord with the present concepts may be optionally used to guide how an insurance re-quoting operation is to be conducted, and these one or more insurance re-quoting parameters may be entered by any person, computer system or service, or entity, and which may comprise actual data, derived data, estimated data and/or assumed data. The insurance re-quoting parameter(s) may be used, for example, to constrain how the insurance re-quoting is to be performed, such as by imposing limitations on the insurance carriers to be accessed, directly or indirectly, or the insurance products to be assessed.

As noted above, in accord with the present concepts, one or more insurance re-quoting triggers are associated with any person, a customer and/or insurance customer data set, such insurance re-quoting triggers including, for example, triggering events or conditions that would cause initiation of an insurance re-quoting operation. In accord with at least some aspects of the present concepts, the insurance re-quoting trigger(s) may include information that is not specific to a particular person, customer, or insurance customer data set, but rather from a class of people having at least some similar data characteristics to the person or customer and, as a characteristic of the class changes, either the customer or people like the customer, such changes can be used to trigger a re-quoting operation and/or modify a set of insurance re-quoting parameters for the customer.

Additional insurance re-quoting triggers can include, for example, data coming in on rate filings by insurance carriers. For example, if State Farm submitted a rate filing in Georgia for auto, such rate filing and/or subsequent approval of the rate filing can then be used to prompt a party providing an insurance re-quoting provider to initiate a re-quoting operation for its customers that have not otherwise excluded State Farm as a potential provider of interest.

As noted above, insurance re-quoting triggers can include not only market change or changes, such as a rate filing noted above, but also a customer's change(s). Customer data comprising insurance re-quoting triggers may include, but is not limited to, a material change in a customer's credit score, voluntary change(s) (i.e. customer buys a new car, gets married, moves, etc.) and/or involuntary change(s) (customer has a birthday, an accident falls off a customer's record, etc., as noted above). The provider of re-quoting operations, in accord with at least some aspects of the present concepts, can set up one or more alerts with one or more credit bureaus or credit monitoring services to let the provider know any time the customer's credit changes by a certain amount (e.g., a set score threshold, a certain percentage change, etc.) reasonably likely to have an effect (e.g., a material affect) or a predetermined effect (e.g., a preset threshold) on the customer's overall risk profile or potential claims. Such changes (e.g., in the credit rating) could then prompt initiating of re-quoting operations for the customer.

Even where one or more re-quoting triggers are satisfied, prompting initiation of a re-quoting operation, it is possible that the insurance customer data set may not initially include all information necessary for the re-quoting operation to be performed. For example, a re-quoting parameter may require that the re-quoting operation is to be performed only if particular data fields have been updated or confirmed within a predetermined period of time. As another example, a re-quoting parameter may require the re-quoting operation to include re-quoting of both an auto policy and a home policy, but some data required for the home policy review was not stored in the insurance customer data set. Thus, it is possible that, at the time a re-quoting trigger is satisfied, more data is needed to give effect to the triggered re-quoting operation and the insurance customer data set may be supplemented, as needed, before or after the re-quoting trigger(s) is/are satisfied, to include all information necessary for the re-quoting operation to be performed. The re-quoting system may directly contact a customer to request input of the needed data or otherwise inform the customer that a re-quoting operation is pending in a queue and will be released following input of information requested of the customer. In other aspects, however, the re-quoting system can obtain information from a customer's Twitter postings, Facebook postings, web browsing history or interaction with any other social networking site, or any information source authorized by a customer (e.g., one or more bank account databases) to supplement and/or update the insurance customer data set as needed. By way of example, social media listening software configured to read all information input into Facebook, Twitter, blogs, etc., such as “Radian6” from Salesforce.com (www.radian6.com), may be used to data-mine such information. Yet further, data in the insurance customer data set may be estimated or assumed, as needed, or may utilized derived data, such as data from a representative group of customers that are similar in one or more characteristics to the customer or other 3^{rd}-party data. Moreover, just as missing data may be supplemented as discussed above, out-of-date data or data that is suspected of being out of date, may likewise be supplemented or replaced by third-party data, estimated data, assumed data, or derived data.

As another example, re-quoting triggers for re-quoting operations may be populated with data from software configured to track a customer's web browsing history, such as through cookies. Namely, when a server responds to an HTTP request by returning an HTTP object to a client, the server also sends a piece of state information (a “cookie”) that the client system (e.g., a customer's computer) stores. Included in the state information is a description of a range of URLs to which that state information should be repeated back so that, when the client system (e.g., a customer's computer) sends future HTTP requests to servers that fall within the range of defined URLs, the requests will include a transmittal of the current value of the state object. As used herein, a cookie (an HTTP cookie) comprises one or more of a session cookie, persistent cookie, secure cookie, HTTP only cookie, or third-party cookie. These cookies may then be utilized in re-quoting operations. For example, if a customer is specifically looking at a car on a car-buying site or a home on a home-sale related site (e.g., a real estate listing), the car-buying site web-page information (or real-estate information) may be used to ascertain the specific make and model of car (or characteristics of property) in which the customer may be interested. This information may then be applied to the customer's existing insurance data set to generate one or more automobile premium quotes (or real property quote) for one or more insurance carriers to provide the customer with a timely, if not immediate, perspective on the market insurance rates for that car (or property).

One manner in which this information can be obtained in support of the insurance re-quoting process is through a browser plug-in. A customer could optionally download a re-quoting-based browser plug-in that would enable a designated requoting provider to access at least select portions of the customer's browser history (e.g., sites such as AutoTrader.com, CarMax.com, Ford, Volvo, real estate sites, new baby-oriented sites, etc.) and access URLs and state information and utilize re-quoting-utilizable information to automatically and passively update the customer's dataset and facilitate a re-quoting process. In another aspect, as a customer service a re-quoting provider can provide links to numerous websites that could provide meaningful information into the re-quoting process (e.g., AutoTrader.com, CarMax.com, car manufacture's websites, real estate sites, etc.). The destination sites are loaded in an IFrame and a CrossFrame style technique used to communicate between the containing page and the IFrame. In addition, the re-quoting provider can partner with 3^{rd}-party sites to permit the re-quoting provider to identify what a customer is looking at or has looked at on the 3^{rd}-party site. For example—CarMax.com could inform a re-quoting provider as to the year, make and model of the car or cars in which a customer accessed information. Any of the above methods could be used, in whole or in part, or in combination, to support and facilitate any aspect of the re-quoting process.

Other information that could be used in support of insurance re-quoting triggers can include text-mining or data-mining sources of public 3^{rd} party information, such as the news or governmental websites (e.g., the Census Bureau, the Office of the Management of the Budget, etc.). For example, a customer lives in a town in Kansas and is an autoworker (occupation is a typical question for insurance quoting). The re-quoting system text-mines or data-mines the local, national, and/or international news and determines that the GM plant in the customer's town is scheduled to shut down in the next 3 months. The re-quoting system concludes that, because the customer likely works at that plant (e.g., same town, relevant occupation), the customer is likely to have an imminent insurance event (e.g., the customer will lose a job and may need to save money by raising a deductible and lowering limits or may need to move for a new job), in which case the customer may need a new policy. This information may thus be used to get out in front of the situation with the customer. Similarly, there are probably other community-wide events that have personal insurance implications for which text-mining of news would be beneficial (e.g., weather events, economic events, civil unrest, changes in crime profiles, changes in local demographics, etc.).

As to the re-quoting engine driving the re-quoting operations, one goal of the re-quoting operations is to identify current customers who might benefit from market price fluctuations. One of several means to this end is to see if new customers are getting better rates than existing customers who are similar to them. Rather than re-quote everyone all the time, the re-quoting system optionally only re-quotes people who are “like” other people who have recently obtained a better quote. A large number of factors go into the rating algorithms used by insurance carriers, so a simple comparison of customers will not work. Instead, the present concepts may advantageously utilize means by which “likeness” may be determined between customers. Predictive Modeling tools and services may be used to score the insurance company customers, or the insurance re-quoting provider could utilize its own scoring algorithm based on a variety of factors (e.g., a number of drivers, vehicles, state, accident/violation occurrences and severity, credit score, distance to coast, etc.), which may be weighted or not weighted.

The re-quoting engine may use ordination or, more particularly, multi-dimensional scaling statistical methods and tools such as discriminant analysis, cluster analysis and/or neural networks to continuously or periodically derive “likeness” characteristics and groupings of customers for rate comparison. In at least some aspects, a general method may include using the rating factors for all customers as the dataset, determine the factors which make the customers most similar and dissimilar, use these factors for subsequent and faster cluster analysis to group people and compare their rates. For example, those that have quotes higher than the normal range for the group would be selected for re-quoting. As another example, those that have rates higher than the normal range for the group would be selected for re-rating. Furthermore “likeness” of customers based on characteristics can be determined by Artificial Intelligence methods, such as pattern recognition, or self-organizing maps. In yet another aspect, a general method may include using all factors in a customer dataset for all customers as the dataset, rather than just the rating factors, determine the factors which make the customers most similar and dissimilar, use these factors for subsequent and faster cluster analysis to group people and compare their rates.

As shown in FIG. 1, the aforementioned method also includes an act S120a of outputting the insurance customer data set to one or more insurance carrier(s), via a communication device, to obtain respective insurance quote(s) or an act S120b of outputting the insurance customer data set, via a communication device, to an internal or external manufactured rating system to obtain respective estimated insurance quote(s). By way of example, act S120a may comprise transmitting the insurance customer data set to an insurance carrier (e.g., Kemper, etc.), web aggregator, internet insurance agency, or third party comparative rating platform or service, via one or more wireless or wired communication device(s) (e.g. cell phone, modem, cable, etc.), responsive to satisfaction of the re-quoting trigger (e.g., lapse of a period of time) in act S110, to obtain a first insurance quote for a first insurance policy from the first insurance carrier (i.e., Kemper in the present example) or alternatively from a web aggregator, internet insurance agency, or third-party comparative rating platform or service (collectively referred to, in general, as a “third party service”). A web aggregator is one subset of insurance-related services, vendors or websites and may comprise, but is not limited to, a lead aggregator or an internet agency. An internet insurance agency allows the customer to enter one set of risk information and the agency will transmit that data to carriers who will return a rate and display that on the screen still within the agency's website. A comparative rating platform or service is a service that allows for the single transmission of rating data to the service which then forwards that dataset to multiple carriers, receiving a quote-response from those carriers in return and aggregating those responses. In contrast, an insurance re-quoting provider, as used herein, stores the insurance customer data set and updates and monitors the market on behalf of the insurance customer thereafter. At least some aspects of the present concepts may advantageously utilize a lead aggregator, which allows a customer to enter one set of risk information to which the aggregator then transmits that information in the form of a lead to carriers and agents who then contact the customer directly for the purpose of providing a quote.

Act S120a may optionally include, for example, outputting the insurance customer data set to a second insurance carrier (e.g., USAA, etc.), via one or more wireless or wired communication device(s) (e.g. cell phone, modem, cable, etc.) to obtain a second insurance quote for a second insurance policy from the first second insurance carrier (i.e., Kemper in the present example). Act S120a may optionally include transmitting the insurance customer data set to a third insurance carrier (e.g., Geico, etc.) to obtain a third insurance quote for a third insurance policy of the same type as the insurance policy quotes from the first and second insurance carriers.

In contrast, in act S120b, the act S120b of outputting the insurance customer data set, via a communication device, to an internal or external manufactured rating system to obtain respective estimated insurance quote(s) may yield multiple estimated insurance quotes from multiple insurance carriers for the single output of relevant insurance customer data thereto.

The insurance quote received in act S130a may include such elements as the premium charged, the policy term length, fee details, billing options/details, coverage details, feature details (features would include things like accident forgiveness for example which is a non-coverage benefit), discount details, among other items. Likewise, where an internal or external manufactured rating system is used, the estimated insurance quote received in act S130b may include such elements as the estimated premium, estimated policy term length, estimated fee details, billing options/details, estimated coverage details, etcetera.

Following receipt of the insurance quotes(s) in act S130a or the estimated insurance quotes(s) in act S130b, the re-quoting of FIG. 1 includes, respectively, the act S140a of comparing, using at least one processor, the insurance quote(s) to determine if any of the insurance quote(s) satisfy one or more betterment criteria or the act S140b of comparing, using at least one processor, the estimated insurance quote(s) to determine if any of the estimated insurance quote(s) satisfy one or more betterment criteria. As previously noted, in accord with at least some aspects of the present concepts, the betterment criteria may comprise a predetermined relative difference between such insurance quote(s) or estimated insurance quote(s) and a customer's current policy or policies.

The “betterment” determination is generally defined by at least one of three general categories: better price, better policy (i.e. coverage, features, billing, etc.) or a better carrier (i.e. higher financial rating, better customer satisfaction rating, better or easier underwriting process, etc.). Between any or all of these categories, it is determined whether differences between the price, policy and/or carrier result in a “net betterment” for the customer. Determining a condition of “betterment,” even for something as facially simple as determining a better price, can be complicated. For example, what if a new auto quote is $25 cheaper, but if a customer moves his or her auto policy from his or her current insurance carrier, he or she will lose a $50 discount on the home policy he or she has with the same insurance carrier? That does not result in a net savings or betterment of the customer's position. Accordingly, aspects of betterment in accord with the present concepts include consideration of lost discounts across policies, fees and other cost measures. In terms of a “better” policy, such betterment could take the form of better coverage (e.g., higher limits, lower deductibles, broader language in terms of covered events/assets/other, etc.) or better features (e.g., more optimal billing options, accident forgiveness, etc.). In accord with the present concepts, one or more betterment criteria may be specified in the absence of an existing insurance policy. In other words, an uninsured person that is a new customer of a re-quoting provider may specify one or more desired betterment criteria that are then used by the re-quoting provider to assess re-quoting operation results.

In terms of a better carrier, that could be assessed in terms of financial strength rating, customer satisfaction ratings, etc. Included in these betterment assessments are a customer's preferences, both stated and inferred, based on their input, their actions, or the actions of similarly-situated customers (e.g., people falling in one or more similar categories as the customer). For example, a customer might state that they don't want to switch unless they save at least $50 annually, or they might state that they don't want to go with an insurance carrier who has a financial strength rating of less than A−. The customer can define any number of parameters that matter to them. Alternatively, or in addition, the methods herein can infer a customer's preferences based on their own prior actions. For example, if the customer previously saw insurance quote #1 ($500) and insurance quote #2 ($550) where insurance carrier #1 had a customer satisfaction rating of 4 stars and insurance carrier #2 had a customer satisfaction rating of 5 stars, and the customer purchased insurance quote #2, it can be inferred that the benefit of having a 5 star versus a 4 star insurance carrier is worth at least $50 to that customer. This inferred information is advantageously utilized, in accord with at least some aspects of the present concepts, to help the assessment of what the customer would value as a “betterment” in the future. This same inferential calculus can be performed on any number of the noted differences between the price, policy and/or carrier and may further be extended to inferences based on like analysis of actions and inputs by, or inferred from, similarly situated groups on other insurance customers.

Regarding determination of “betterment” when comparing one policy from an insurance quote of insurance carrier #1 versus a like policy from an insurance quote of insurance carrier #2, one option in accord with aspects of the present concepts is to utilize expert assessment of the contractual language of the insurance quotes or automated scoring of provisions in such quotes. In some aspects, the present concepts are taking a non-monetary variable and monetizing the variable to permit comparison with like variables and, optionally, further adjusting such monetized variable upwardly or downwardly based on external factors such as, but not limited to, customer expressed or inferred preferences. For example, different aspects of the insurance quote terms can be scored/valued, using judgment or using actuarial analysis, to provide relative measures of the economic difference, or expected economic difference, between the policy language in different quotes. Actuarial analysis or judgment could also be used to value the difference in other variables such as, but not limited to, coverage limits and deductible amounts.

Yet additional factors in determining a “betterment” to a customer's position includes determining whether one insurance carrier is better for the customer than another insurance carrier. This condition may include, for example, expert assessment of the different insurance carriers in terms of service, claims and/or financial stability that could be scored/valued using judgment, publically-available objective rating information, publically-available subjective rating information (e.g., social media, etc.), or using another method such as inferential analysis. Additional items that could be considered when assessing carrier could be consumer complaint statistics (either those complaints received by the company or with departments of insurance or other 3^{rd} parties), statistics on a carrier's success on departments of insurance market conduct exams (these are regular examinations that determine whether a carrier is acting properly in terms of regulations, filings, etc.), the average timeliness of a carrier's claims process or responsiveness when performing other service activities, or other potential measures.

To generally summarize some of the terminology used above and herein, one or more insurance re-quoting triggers are used, in accord with aspect of the present concepts, to initiate a re-quoting operation. One or more insurance re-quoting parameters are used, in accord with aspect of the present concepts, to define how an insurance re-quoting is to be performed (e.g., where to search, etc.). One or more re-quoting betterment criteria or conditions are then used, in accord with aspect of the present concepts, to evaluate the information returned from the insurance re-quoting operation.

The re-quoting engine can learn not only from actions, data and/or relative decisions made by the customer (or potential customer), but also from actions, data and/or relative decisions made a group or population that is defined to be or found to be similar to the customer (or potential customer) in one or more correlatable aspects. By way of example, if a customer is provided with a selection between two identical policy coverages, with a first insurance provider having an “A−” service rating offering a $900 premium and with a second insurance provider having an “A+” service rating offering a $925 premium, the processor-based re-quoting computer system or re-quoting engine can determine from a customer's selection of the second insurance provider that the difference of $25 in premium is not as important a variable as the difference in rating “A+” vs. “A−” in service rating. This information is then factored into the insurance customer data set to provide intelligent re-quoting in later iterations of re-quoting for the customer and/or for other populations or customer clusters correlating to the customer.

As another example, the processor-based re-quoting computer system or re-quoting engine, draws inferences from a customer's decisions of multiple different offerings. If a customer is presented with the three options depicted in Table 1, below, when purchasing their auto policy, and the customer chose to purchase from Carrier 2, the inference can be drawn that the combination of a higher Financial Strength rating of “A” versus “A−” and a higher Consumer Rating of “4 stars” versus “3 stars” was worth at least $100 to that customer. Additionally, the inference can be drawn that the increase in Financial Strength from “A” to “A+” with no change in Consumer Rating is worth something less than $75 (moving from Carrier 2 to 3) since the customer did not select Carrier 3 even with the improved attributes. This knowledge will be used to better understand what would be viewed as an “improvement” to the customer.

TABLE 1

| | Financial Strength | Consumer Rating | Price |
|---|---|---|---|
| Carrier 1 | A− | 3 Stars | $1000 |
| Carrier 2 | A | 4 Stars | $1100 |
| Carrier 3 | A+ | 4 Stars | $1175 |

The processor-based re-quoting computer system may employ Factor Analysis, Cluster Analysis, Adaptive Resonance Theory methods, Neural Networks, Fuzzy Logic, Markov Models, and/or other Artificial Intelligence techniques, for example, singly or in combination.

The betterment assessment may be derived without describing betterment in terms of financial benefit or value to the customer. For example the processor-based re-quoting computer system may employ Factor Analysis, Principle Components analysis, multidimensional scaling or Regression Analysis methods to determine relative weights of various features of policies and quotes to determine net betterment solely based on a populations expressed preferences. By comparing the quotes or policies that a population of customers selected versus those that were not selected, such an analysis could determine the customer's weightings of the factors or features of the quotes or policies. For example, using the data in Table 2 (below), if an analysis of a population's past behavior determined that customers weigh the Consumer Rating factor at four times the weight of the BI Coverage factor, then it is unlikely that Scenarios 2 and 5 for Carrier B would represent a net betterment for a customer. Such methods in essence derive a formula for determining net betterment without expressing the factors in monetary terms. The above example and list of statistical methods is a simplified example of the application of using statistical methods to determine net betterment, neither the example nor the list of methods should be construed as being comprehensive, rather illustrative of the technique.

TABLE 2

| | | Customer | Premium | BI | Financial |
|---|---|---|---|---|---|
| Scenario | Carrier | Rating (stars) | (dollars) | Coverage | Rating |
| 1 | A | 3 | 1000 | 25/25 | A |
| 2 | B | 2 | 1000 | 25/25 | A− |
| 3 | A | 3 | 1100 | 25/50 | A |
| 4 | C | 3 | 1300 | 25/25 | A+ |
| 5 | B | 2 | 900 | 20/40 | A− |
| 6 | C | 3 | 1200 | 20/40 | A+ |
| X | D | 3 | 1050 | 25/50 | A |

An alternative method for assessing net betterment is to use pattern recognition such as is commonly implemented in Artificial Intelligence (AI). Using this method, the system is fed data, a simplified example of such is provided in Table 2 (Scenarios 1-6), and the AI learns the pattern of customers preferred selections. For example, if a population of customers presented with the quote or policy scenarios in Table 2 most frequently select scenario 3, then the system learns that this pattern is preferred (net better) over the other scenarios. If a customer is presented with Scenario X as in Table 2, such a system may match the new scenario to the “learned” scenario 3 pattern. Further, since the “learned” pattern for Scenario 3 is preferred, the system will infer that the new Scenario X is likely to be preferred and selected.

In addition to the above statistical and Artificial Intelligence methodologies, other mathematical methods such as Adaptive Resonance Theory, Markov Models, and Fuzzy Logic can be employed. These techniques can be employed either singly or in combination.

The processor-based re-quoting computer system is optionally adapted to provide assistance to the customer, such as but not limited to, providing coverage suggestions or altering the order in which items (rates, questions, tabs, etc.) are displayed to the customer, analyzing when a quote is “better” for the customer taking into account non-monetary factors such as carrier preference, carrier features, etc. (as noted elsewhere herein), presentation of additional coverages or products that a customer is likely to be most interested in, selecting which specific carriers to rate for a customer, and predicting the lifetime profitability of a customer at any point in time while they are a customer. In yet other aspects, the processor-based re-quoting computer system is optionally adapted to provide assistance to an insurance carrier or an insurance re-quoting provider. Customer data, whether obtained directly or indirectly, and whether actual data, derived data, estimated data, or assumed data, can be used to the benefit of the insurance carrier or an insurance re-quoting provider. For example, GPS data for a customer's car could be used to detect discrepancies between customer-entered data (e.g., declared vehicle usage as pleasure only) and GPS-derived data (e.g., GPS data showing vehicle driven to/from insured's work/home 5-days a week for a period of time).

It is further to be emphasized that the “net betterment” can comprise a betterment assessment for any individual category or any combination of categories without limitation and the “net betterment” is a measure of a completion of the betterment assessment, using a particular category or population of categories. Moreover, this process can be performed for one or more insurance products at the same time.

Following the determination of whether or not the insurance quote(s) of act S140a or estimated insurance quote(s) of act S140b result in a betterment, the method includes the act S150 of taking further action(s) specified by customer if any of the insurance quote(s) or estimated insurance quote(s) satisfy one or more of the betterment criteria. In this regard, the customer is able to specify how they would prefer to receive notice of the comparison results. Alternatively, or in addition, the customer could authorize the re-quoting provider to act as their agent and sign them to a policy or policies, as applicable, where a certain betterment condition or conditions are fulfilled (or estimated to be fulfilled).

In at least some aspects of the present concepts, where a manufactured rating system is utilized in accord with acts S120b, S130b and S140b, act S150 may further comprise subsequent execution of acts S120a, S130a and S140a specific to the insurance carrier for which the estimated insurance quote(s) were expected to satisfy a betterment condition.

Where acts S140a and/or S140b do result in a finding that a betterment condition is satisfied, however “better” is defined (e.g., defined explicitly by the customer, defined implicitly by the customer, defined based on an assessment of a similar group of people, defined based on expert opinion, etc.), the customer is notified in at least some aspects of the present concepts (see, e.g., act S150 of FIG. 1) to empower the customer to take action or to provide appropriate instructions (e.g., accept an offer for a new policy from another insurance company, alter a re-quoting trigger, alter a betterment condition, etc.). By way of example, a customer may set one or more betterment condition(s), satisfaction of which would cause the customer to entertain a switch to (or automatically switch to) another insurance carrier. These factors could be as simple as a mere price differential, for example, or a complex aggregation of policy term, policy price, specified policy conditions, and insurance carrier rating.

As one example of a customer-specified betterment condition, a customer may (1) never want to switch to a company with less than an “A” rating, (2) never want to split home and auto policies between different companies, and (3) never move to Progressive, or any combination thereof. As previously noted, such betterment condition(s) could be customer-originated entries or, alternatively, optionally derived by the system responsive to repeated customer inputs (e.g., multiple declining of offers to move to Progressive) to intelligently (e.g., via artificial intelligence (AI)) enhance an understanding of customer preferences and provide options most likely to comport with a customer's desires.

A more detailed example follows where the re-quoting engine assesses the switching costs when determining when another option for insurance is an “improvement” or is “better” in some way. In this example, a customer has a current 6-month auto policy having a total cost of $650, comprising a $600 premium spread pro-rata over the 6-month policy period and a $50 non-refundable policy fee charged on Day 1 of the term. It is exactly 3 months into the policy term. The re-quoting provider has re-quoted the customer and found a company willing to offer a rate of $630 for 6 months with no fees, all premium. Is this an improvement? No. The reason is that with the current policy, the $50 fee is sunk and you are currently paying at a run-rate of $100 per month. Even though the new policy has a lower 6-month cost than the current policy, the going-forward cost is $105 per month for the new policy versus $100 per month for the old. In another example, the customer has a $600 6-month policy (all premium) and it's exactly 3 months into the policy term. The current policy has a cancellation fee associated with it of $25. If the re-quoting provider finds a new policy at $580, for example, this would not be an improvement. Instead, only a prospective new policy having a rate of $574 or less would permit realization of a cost-based improvement, although such minimal savings may not satisfy the customer's betterment criteria for a cost-savings. In yet another example, the customer has a $600 6-month policy (all premium) and it's exactly 2 months into the policy term. The current policy has a short-rate provision which upon cancellation allows the current insurer to keep 10% of the unearned premium. If the customer canceled today the unearned premium would be $400 (we've gone 2/6th of the way through so 2/6th of the $600 term premium is earned and 4/6th is unearned). Therefore the carrier would keep an additional $40 today upon cancellation. Therefore, a new-quote would need to be $539 or less to be an “improvement” today.

The aforementioned method, and other methods and systems described herein, provide tools for proactively and adaptively managing a customer's insurance portfolio using a variety of data sources including, but not limited to, customer-entered data and customer data obtained from third-party sources, both customer-specific data and customer-related data represented by aggregated data or statistical samples or populations. Not only are the presently disclosed methods and systems adapted to receive inputs from a customer to enable the customer to control or influence aspects of re-quoting operations for the customer (e.g., specification of one or more betterment conditions, etc.), but are further adapted to be adaptive, actively utilizing direct customer inputs to identify opportunities to further benefit the customer and advantageously receiving inputs from sources other than direct customer inputs into an insurance re-quoting provider GUI or the like. By way of example, instead of passively issuing a policy for a set term, following which the customer pays premium payments at designated times, the present concepts enable active monitoring of information that could affect the customer's rating with respect to the active insurance policy (e.g., customer life events, market changes, marriage/birth/death, threshold change in age, accident removed from record or “forgiven” after 3 years, etc.) and proactive actions to inform a customer of alternatives that satisfy one or more betterment conditions specified by a customer, or derived from information relating directly or indirectly (e.g., derived data, related groups, etc.) to such customer.

The present concepts, moreover, are not limited to a strict policy to policy comparison (e.g., home policy of insurance carrier A to home policy of insurance carrier B or a plurality of insurance carriers, etc.), but are instead amenable to evaluations of a customer's entire insurance portfolio. This system intelligence, applied to the entire insurance portfolio (e.g., auto, boat, life, home, etc.) specifically addresses interactions (pricing/coverage) between policies that can reveal savings (or hidden costs) associated with changes to any part of a customer's entire insurance portfolio. For example, in a case illustrating a potential loss of a multi-policy discount, a customer of insurance carrier A has an automobile and a home policy with a corresponding a multi-policy discount. A re-quoting provider utilizing a system configured in accord with at least some aspects of the present concepts may conduct a re-quoting operation for the customer's automobile policy following some trigger (e.g., an accident forgiveness on a 3^{rd} anniversary date) and transmit relevant portions of the customer data to four other insurance carriers B-E to determine whether the customer's data would provide a lower insurance policy premium at any of those other insurance carriers. The preliminary results could indicate that the customer would enjoy a premium-based cost savings switching their automobile policy to insurance carrier C, but insurance carrier C is determined to also charge a higher premium for comparable home insurance for the customer and/or not provide similar bundled benefits of having multiple policies with the same insurance carrier, yielding a net loss for the customer if the customer were to move one or both policies to insurance carrier C. Thus, although the present concepts may be applied to individual policies in isolation (e.g., only auto insurance, only home insurance, etc.), the present concepts present a powerful tool to enable comprehensive review of entire customer insurance portfolios and to assess the impact of fees, charges or costs associated with any policy changes individually or in the aggregate (e.g., assessing impact of a financial offset resulting from policy fees and short rate fees).

Consistent with the above-noted assessment of interactions between policies by the re-quoting engine when determining when another option is an improvement or betterment for the consumer, the following examples illustrate such features. In a first example, a customer has a 12-month auto policy for $1200 and a 12-month home policy for $600, both policies being with the same insurance carrier. The auto policy includes a multi-policy discount of $100 and the home policy has a multi-policy discount of $50, both discounts requiring that both policies are insured with the same carrier. When the re-quoting operation is performed, the re-quoting provider looks for other potentially better options for the customer. When re-quoting for auto, the re-quoting provider finds that another carrier will provide a monoline rate (just one policy is insured by that one carrier, in contrast to multi-line where the customer has more than one policy with that one carrier) of $1160. In isolation, this appears to be $40 better than the current $1200 auto policy but, in fact, if the customer placed their auto policy with a new carrier, their current carrier would remove the multi-policy discount from their remaining home policy, thereby increasing that rate by $50 and the net effect would be a loss of $10. As another example, a customer has a 12-month monoline auto policy for $1200 with Carrier A and a 12-month home policy for $600 with Carrier B. The multi-policy discount for auto for Carrier A would be $100. The re-quoting provider determines that Carrier A is offering a home quote for $640. In isolation this seems like a loss because it's $40 higher than the current home policy price but if the multi-policy discount is factored in, the transaction is a net benefit for the customer by $60 if the home policy is moved to Carrier A.

Both of the above examples could, yet further, comprise assessments of differences in coverage between having both (or all) policies with one carrier or having the policies split amongst a plurality of insurance carriers. For example, Kemper Preferred provides additional coverage on their homeowners policy for free when the customer has both their auto and home together, however, if you buy just a home policy, this benefit is not realized. So, even if there is no material cost difference, moving a policy may engender a benefit when it comes to coverage or some other aspect of insurance.

As noted above, in at least some aspects the re-quoting engine takes into account features or coverage changes when determining when another option is an improvement or betterment for the customer. For example, a customer has a current policy that's $600 for 6-months and this policy includes “Accident Forgiveness.” A new quote is available at $570 for 6-months. While this is an improvement of monthly run-rate cost from $100 to $95, the new quote does not include Accident Forgiveness and the re-quoting engine (or optionally re-quoting provider) would account for this difference. On an on-going basis, the re-quoting engine may determine that a population of customers similar to the customer of interest valued Accident Forgiveness at about $50 a year (e.g., a statistically significant number of customers choose an option with Accident Forgiveness even if it's $50 more). Therefore, the $30 difference in 6-month cost is trumped by the $50 difference in additional value provided by the availability of the Accident Forgiveness feature. As another example, the re-quoting engine takes into account features and assesses future features gained. For example, a customer has a current policy that's $600 for 6-months, which is up for renewal at the same price next month. Based on the customer's loyal patronage with the insurance provider for 3 years, they will gain a “Disappearing Deductible” feature that lowers their deductible from $500 to $400 for the next policy term. A new quote with a different insurance provider is determined by the re-quoting provider's re-quoting engine at $570 for 6-months. While this is an improvement of monthly run-rate cost from $100 to $95, the new quote does not include Disappearing Deductible. On an on-going basis, the re-quoting engine may determine, by way of example, that a population of customers similar to the customer of interest valued the Disappearing Deductible at about $100 a year, permitting a conclusion that the $30 difference in 6-month premium does not overcome the perceived value provided by the imminent acquisition of the Disappearing Deductible feature, even with the need to pay an excess of $5 difference for the last month of the current term to get to the next term.

In at least some aspects, the re-quoting engine is further configured to take into account billing fees when determining when another option is an improvement or betterment for the customer. For example, a customer has a current policy that is $600 for 6-months and, upon re-quoting, the re-quoting provider finds a new option that is $606 for 6-months. The current policy includes a $10 per month billing fee when the customer pays by credit card (which he does) while the new quote includes only a $1 per month charge. The new option is an improvement as the total monthly cost for the current policy is $110 while the new option is only $102 per month in total cost. When requesting insurance quotes, and when assessing the received insurance quotes for satisfaction of one or more betterment condition(s), the re-quoting provider's output insurance customer data set can include not only the method and frequency of payment currently adopted by the customer, but also include differential assessments of other available payment methods/frequencies to enable subsequent determination of whether or not the received insurance quote(s) provide an improvement satisfying one or more betterment condition(s).

In still additional aspects, the re-quoting engine is adapted to normalize between policies of different term-lengths when determining when another option or options provide an “improvement” for the consumer. For example, the customer has a current 6-month policy for $600 and the re-quoting provider conducts a re-quoting operation and finds a new 12-month quote for $1080. The new quote would be an improvement since the correct comparison would be that the run-rate cost for the current policy is $100 per month and the new quote would instead by only $90 per month.

As illustrated by the above examples, aspects of the re-quoting engine disclosed herein assess the interactions between policies of each queried insurance carrier to properly determine whether or not the net effect of any change for that insurance carrier is an improvement or betterment, whether with respect to price (i.e. multi-policy discounts), coverage and/or other features (e.g., accident forgiveness, disappearing deductible, bill plans, etc.).

In at least some aspects, the methods and systems in accord with the concepts disclosed herein perform a static comparison between insurance carrier A (a current issuer of the customer's insurance policy) and one or more other insurance carriers B-x, where x represents any integer, at a fixed point in time (i.e., the time of the re-quoting operation). However, the methods and systems in accord with the concepts disclosed herein are capable of much more intelligent analyses and are adaptable to perform a dynamic comparison between insurance carrier A (a current issuer of the customer's insurance policy) and one or more other insurance carriers B-x, where x represents any integer, at a plurality of points in time (i.e., looking forward for a period of time beyond the time of the re-quoting operation, such as a life-cycle of a policy). The present methods and systems are therefore capable of looking forward in time to weigh the availability of different cost savings that would occur, or not occur, under a comparable policy issued by other insurance carriers.

For example, were a customer's current 6-month automobile policy term for insurance carrier A to lapse in 4 months, but upon renewal, would benefit from an accident forgiveness in the successive 6-month automobile policy term, this forward-looking cost savings could be directly compared to a 6-month automobile policy or one-year automobile policy of insurance carrier B that uses a 5-year forgiveness period rather than a 3-year forgiveness period. In other words, in such a situation, although a premium or monthly cost for automobile insurance might be shorter at insurance carrier B in the short-term (e.g., in the next four months), the longer-term costs could then end up being higher at insurance carrier B. The present concepts advantageously are predictive and enable evaluation of a complete life cycle, or even plural life cycles of one or more insurance products, either in isolation or in combination with one or more other insurance products (e.g., interactions of policies over time), inclusive of any incentives, applied fees, or discounts that may be applied at a time of the re-quoting operation or in the future. Such fees may include, for example, hard costs such as switching costs, termination fees, policy fees, issuance fees, short rate calculations, or the like, and soft costs (e.g., time).

Additionally, using these concepts, the re-quoting provider can compare differences in billing options and their value to the customer and/tor to groups of customers. For example, a pay-in-full option is more difficult for a 12-month policy than for a 6-month policy because the initial cash outlay is much larger. To some customers, paying monthly or even bi-weekly might be advantageous (e.g., billing frequency might be valuable to those customers), while for other customers, payment method might matter (e.g., credit card, debit, paper bill, or even payroll deduction might be valuable to those customers), while yet other customers might value grace periods or differences in late payment rules/fees.

Yet further, the present concepts lend themselves not only to conventional paradigms of insurance policies based on traditional terms, such as annual or semi-annual policy terms, but also on non-traditional paradigms such as other time-based terms (e.g., monthly, weekly, hourly, etc.), asset-based terms, or usage-based terms (e.g., mileage-based terms where exposure is accumulated per mile). In such non-traditional paradigms, policies are able to be reduced more and more to approximate usage rates (e.g., an hourly rate for a predetermined level of risk protection, etc.). Usage-based insurance policies may include any of the traditional forms of insurance (e.g., boats, motorcycles, homes, automobiles, other vehicles, life, etc.) but also less typical forms of insurance such as rental car insurance, airplane flight insurance, car sharing (e.g., “Zip Car”) insurance, or micro insurance products. In an automobile context, an automobile's on-board computer or perhaps a customer's personal electronic device (e.g., cell phone GPS) could transmit data on the location of the car (e.g., providing derivative average velocity/speed information relative to a known speed limit for a roadway), frequency of accelerations indicating lanes changes, accelerations indicating severity of and frequency of braking, etcetera. These data feeds, particularly in the non-traditional paradigms or usage-based models, can be actively re-quoted at frequent intervals (e.g., a temporal re-quoting trigger of a specified time period) or responsive to inputs from such on-board electronic devices. Accordingly, the present concepts can be adapted to continuously monitor a customer and to continuously assess whether a customer's data (e.g., actual driving data) supports a lower premium (or usage rate) from another insurance carrier. Correspondingly, after switching to another insurance carrier, the same re-quoting operations using time-modified customer data (e.g., altered driving behavior) may later reveal that a switch to yet another insurance carrier or back to the original insurance carrier would then provide a better quote (or usage rate).

Similar usage-based data could also be obtained from other data-sources. For example, for a home insurance policy, data on alarm usage may be provided directly by a customer (e.g., alarm activation and deactivation is linked to an insurance carrier computer system) or indirectly through a third-party monitoring system. Improvements on the property could also be monitored, such as by scanning of databases of local municipalities for permits issued for a property in question (e.g., installation of a pool, fence, or deck) and factored into re-quoting operations. Using another example, life or health insurance re-quoting operations may advantageously utilize data from customer-embedded devices or customer-utilized devices (e.g., electronic devices such as the Robert Bosch Healthcare System's “Health Buddy” appliance or other tele-health device that collects and transmits (e.g., via wireless modem, phone line, Ethernet, etc.) patient data such as vital signs, symptoms and behaviors from one or more appurtenant medical devices such as blood glucose meters, weight scales and blood pressure monitors, via a communication interface, to a data center. This health-based data may then be used in re-quoting operations to find the customer the “best” (as defined by the customer) fit insurance policy for the customer on an active and ongoing basis.

Switching from one insurance carrier to another insurance carrier often entails switching problems. For example, a new home insurance policy may require a home inspection if the house is valued above a predetermined threshold value, which causes the customer to incur a switching cost. Another switching problem is technology-based and is ameliorated by simplification of the customer input required to effect beneficial changes to the customer's insurance policy or policies. For example, once the re-quoting system processor(s) has (have) determined that a net cost difference in switching from a first insurance carrier to a second insurance carrier exceeds a re-quoting threshold value (e.g., user-defined), the result (e.g., a net cost difference, a premium quote, an alert of a predefined customer-selected benefit, etc.) is communicated in some form (e.g., electronically) to a customer (e.g., to a customer's personal computer, cellular phone, etc.). To minimize an informational burden, the methods and systems of the re-quoting provider may advantageously communicate such information to a customer only if a determined benefit, of any type, exceeds a threshold value specified by the customer.

As one illustration, for a Kemper customer, an insurance re-quoting provider's system can send re-quoting queries to Travelers and Safeco on an automobile policy for the customer and Safeco is determined by the insurance re-quoting provider, using betterment criteria, to offer quotes more beneficial to a customer. Since the insurance quote was already premised on the customer's known information, the insurance re-quoting provider's system can send requisite information on the benefits available to the customer together with a link or button in a GUI (e.g., on the customer's cell phone display) indicating to the customer that they can make the switch to Safeco by pressing an “OK” button, which would serve as the customer's e-signature, to enable underwriting along with policy and ID (physical and/or digital) issuance.

To satisfy various local requirements in a customer's state, certain language may be presented in combination with such button(s) or link(s), such as an affirmation of the truthfulness of the information upon which the quote(s) was (were) based. Further, local requirements may require a customer to input electronic signatures for certain coverages that are expressly declined. Payment, where required for issuance of a policy, could also optionally be pre-authorized to a customer's credit card or other financial account, or could require input of information by the customer sufficient to allow money to be transferred from an existing account. This simplified policy issuance platform also optionally requires the customer to review and verify the correctness of the information used to issue the insurance policy.

As one illustration, a customer of an insurance company (e.g., Kemper) may be about to move and they put their house up on the market via MLS. The re-quoting system obtains MLS data and, determining that an address of an insured has been listed, self-initiates a re-quoting operation to determine how a move could impact the customer. Since the re-quoting system does not yet have a destination address, the re-quoting system is not able to definitively assess the impact of house change or vehicle (car, motorcycle, boat) change. The re-quoting system may then optionally search other known customer data sources, such as Facebook or Twitter accounts to determine if there is actionable intelligence therein (e.g., “we are moving to Chicago, Ill.!”) to provide context. Absent such information, the re-quoting system may contact the customer (e.g., via text, email, voice message, etc.) to inform the customer about next steps in the process, such as outlining the information that is required to perform re-quoting operations on the customer's behalf to find the customer the best deal and taking the opportunity to discuss the customers current policy or policies.

In at least some service models, re-quoting services could be subscription-based and/or charge commission(s) based on savings achieved.

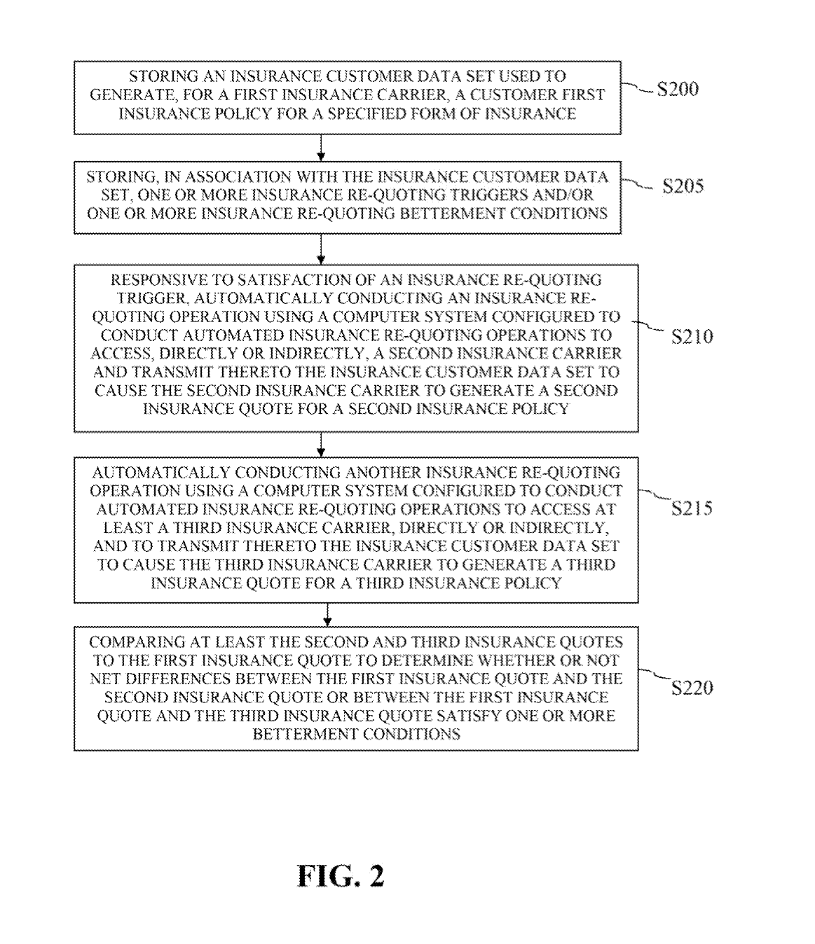

FIG. 2 shows a flowchart for a method for performing automated re-quoting in accord with at least some aspects of the present concepts. A first act S200 includes storing an insurance customer data set used to generate, for a first insurance carrier, a customer first insurance policy for a specified form of insurance. The act of storing includes storing, in at least one physical storage medium (e.g., any computer-readable media including, for example, a hard disk, CD-ROM, DVD, RAM, flash drive, memory chip, etc.), the insurance customer data set used to generate, for the first insurance carrier, the customer first insurance policy for a specified form of insurance (e.g., an automobile insurance policy).

A second act S205 includes storing (e.g., in one or more physical storage mediums), in association with the insurance customer data set, at least one insurance customer input relating to one or more insurance re-quoting triggers and/or one or more insurance re-quoting betterment conditions. The insurance re-quoting trigger(s) and/or insurance re-quoting betterment conditions are, in at least some aspects, selectable by the customer. The re-quoting trigger(s), as noted above, can include any trigger(s) and can include, for example, any temporal limitation(s), non-temporal limitation(s), or combination(s) thereof. The betterment condition(s) likewise can comprise conditions that are important to a customer in making an advance determination as to whether a switch in insurance carrier, a switch in insurance products (e.g., consolidation of insurance policies, etc.), a switch in coverage, or the like, would be of interest to the customer. For example, a betterment condition could simply comprise a threshold cost differential for which the customer would contemplate switching (i.e., they would desire to be notified of such potential saving) or would agree to automatically switch without further input from the customer (e.g., they have decided in advance that a certain saving is definitely worth switching and for which the customer does not necessarily require communication from the insurance re-quoting provider).

In addition to the insurance re-quoting trigger(s) which initiate the insurance re-quoting operation, and the betterment condition(s) which assesses whether insurance quotes received responsive to insurance re-quoting operation, the customer may in accord with at least some aspects of the present concepts further specify one or more insurance re-quoting parameters defining boundaries for the re-quoting operation. By way of example, such insurance re-quoting parameters may include limitation of the insurance re-quoting operation to a specific listing of insurance carriers to contact in the re-quoting operations, limitation of the insurance re-quoting operation to a listing of insurance carriers not to contact in the re-quoting operations, limitation of the insurance re-quoting operation to a specific deductible level, limitation of the insurance re-quoting operation to one or more required coverages, etcetera.

The method depicted in FIG. 2 also includes, in act S210, automatically conducting an insurance re-quoting operation responsive to satisfaction of an insurance re-quoting trigger. The insurance re-quoting computer system, comprising at least one processor and a communication device, performs an automated insurance re-quoting operation by accessing a second insurance carrier and transmitting thereto the insurance customer data set. Responsive thereto, the second insurance carrier generates and returns to the insurance re-quoting computer system a second insurance quote for a second insurance policy. In at least some aspects, act S210 includes using the insurance re-quoting computer system to accesses a second insurance carrier and to transmit the insurance customer data set to the second insurance carrier to cause the second insurance carrier to generate a second insurance quote for a second insurance policy for the specified form of insurance. Act S215 likewise includes automatically conducting another insurance re-quoting operation using a computer system configured to conduct automated insurance re-quoting operations to access at least a third insurance carrier and to transmit thereto the insurance customer data set to cause the third insurance carrier to generate a third insurance quote for a third insurance policy.

In a further act S220, the method then compares at least the second and third insurance quotes to the first insurance quote to determine whether or not net differences between the first insurance quote and the second insurance quote or between the first insurance quote and the third insurance quote satisfy one or more betterment conditions. The net betterment may comprise, for example and without limitation, a better price, one or more improved policy terms, and/or a better carrier, in any combination. By way of example, a first net cost difference is calculated between the first cost and the second cost and to determine a second net cost difference between the first cost and the third cost. As mentioned above, the net cost of a policy may consider not only a premium for the policy, but may also consider any other related up-front, on-going, or back-end fees or costs. The results may be optionally presented in rank order based on one or more selected betterment criteria.

Insurance re-quoting operations in accord with the present concepts, and in accord with the method represented in FIG. 2, may be conducted responsive to an insurance re-quoting trigger or set of insurance re-quoting triggers comprising a derived insurance re-quoting trigger (e.g., inferred customer data, triggers associated with a similar group of customers, etc.). Further, insurance re-quoting operations in accord with the present concepts may be initiated responsive to one or more derived insurance re-quoting triggers and/or conducted responsive to one or more derived insurance re-quoting parameters and/or evaluated responsive to one or more derived insurance re-quoting betterment conditions.

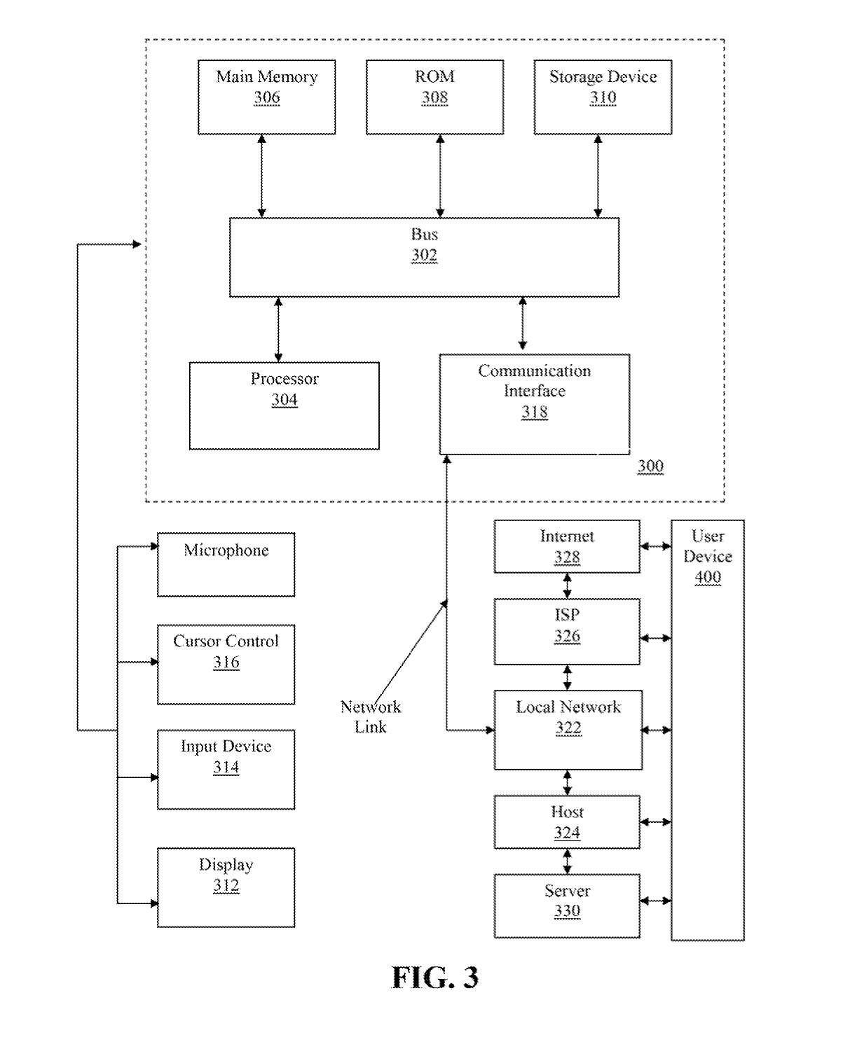

FIG. 3 is a block diagram that illustrates an example of a computer system 300 upon which embodiments of the present concepts may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions (computer program) to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as an LCD display, for displaying information to a computer user. An input device 314, such as alphanumeric and other keys, microphone 317, etcetera, is coupled to bus 302 for communicating information and command selections to processor 304. Another type of user input device is cursor control 316, such as a mouse, a trackball, touch screen, touch pad, track pad, electronic pen, magnetic pen, retinal scanner, or cursor direction keys, for communicating direction information and command selections to processor 304 and for controlling cursor movement on display 312.

The invention is related to the use of computer system 300 for practicing the various aspects of the present concepts disclosed herein. According to one embodiment of the invention, various aspects of the present concepts disclosed herein are provided by computer system 300 in response to processor 304 executing one or more sequences of one or more instructions contained in main memory 306. Such instructions may be read into main memory 306 from another computer-readable medium, such as storage device 310. Execution of the sequences of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium (or media) that participates in providing instructions to processor 304 for execution. Such a medium may take many forms, including but not limited to, non-volatile media, volatile media, and transmission media. Non-volatile media include, for example, optical or magnetic disks, such as storage device 310. Volatile media include dynamic memory, such as main memory 306. Transmission media can include, for example, coaxial cables, wire, metallization layers, organic conductors, and fiber optics, including the wires that comprise bus 302. Transmission media can also take the form of electromagnetic waves (e.g., radio frequency (RF), light waves, infrared (IR), etc.). Common forms of computer-readable media include, for example, a floppy disk, a flexible disk, hard disk, magnetic tape, any other magnetic medium, a CD-ROM, DVD, any other optical medium, any other physical medium with computer-readable patterns (e.g., holes, protrusions, depressions, etc.), a RAM, a PROM, and EPROM, a FLASH-EPROM, flash drive, any other memory chip or cartridge, or any other medium from which a computer can read.

Various forms of computer readable media may be involved in carrying one or more sequences of one or more instructions to processor 304 for execution. For example, the instructions may initially be borne on a magnetic disk of a remote computer. The remote computer can load the instructions into its dynamic memory and send the instructions over a telephone line using a modem. A modem local to computer system 300 can receive the data on the telephone line and use an infrared transmitter to convert the data to an infrared signal. An infrared detector coupled to bus 302 can receive the data carried in the infrared signal and place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication, via any transmission media, through one or more networks to other data devices. For example, network link 320 may provide a connection through local network 322 to a host computer 324, to data equipment operated by an Internet Service Provider (ISP) 326, or to a cellular network. ISP 326 in turn provides data communication services through the Internet 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms transporting information relating to the present concepts.

Computer system 300 can send messages and receive data, including program code, through the network(s), network link 320, and communication interface 318. In the Internet example, a server 330 might transmit a requested code for an application program through Internet 328, ISP 326, local network 322 and communication interface 318. In accordance with the invention, one such downloaded application provides for various aspects of the present concepts disclosed herein. The received code may be executed by processor 304 as it is received, and/or stored in storage device 310, or other non-volatile storage for later execution.

The user device 400 in FIG. 3, as noted above, could include any user's electronic device configured to connect to a remote computer such as, but not limited to a personal computer, a laptop or notebook computer, a tablet computer, a cellular telephone, a handheld electronic device (e.g., PDA, BlackBerry, etc.), a phone for the hearing impaired, etc. The inputs may be entered using any embedded or connected input device associated with the user's electronic device including, but not limited to, a microphone, key(s), touch screen, motion sensor(s), etc.

Data transfer methods may include, but are not limited to communications with carriers, third parties, or with 3rd party multi-platform rating engines using HTTP/HTTPS POST, HTTP/HTTPS GET, REST, SOAP based web services, FTP/SFTP, Sockets (UDP or TCP), or SMTP/Email. Data may be transmitted in a compressed or uncompressed state, encrypted or unencrypted, via any conventional or proprietary format. Formats may include, for example, XML, delimited or fixed length data. Communications with customers may be had, for example, via SMS. Email/SMTP, or RSS feeds.

In accord with the concepts disclosed herein, an automated intelligent re-quoting system is provide in which the system is adapted not only for improving offerings to customers, but is also self-updating, being configured to integrate non-traditional data sources, such as social media commentary, web-site browsing information, and public information to prompt reassessment of the customers policies, coverage, and/or options.

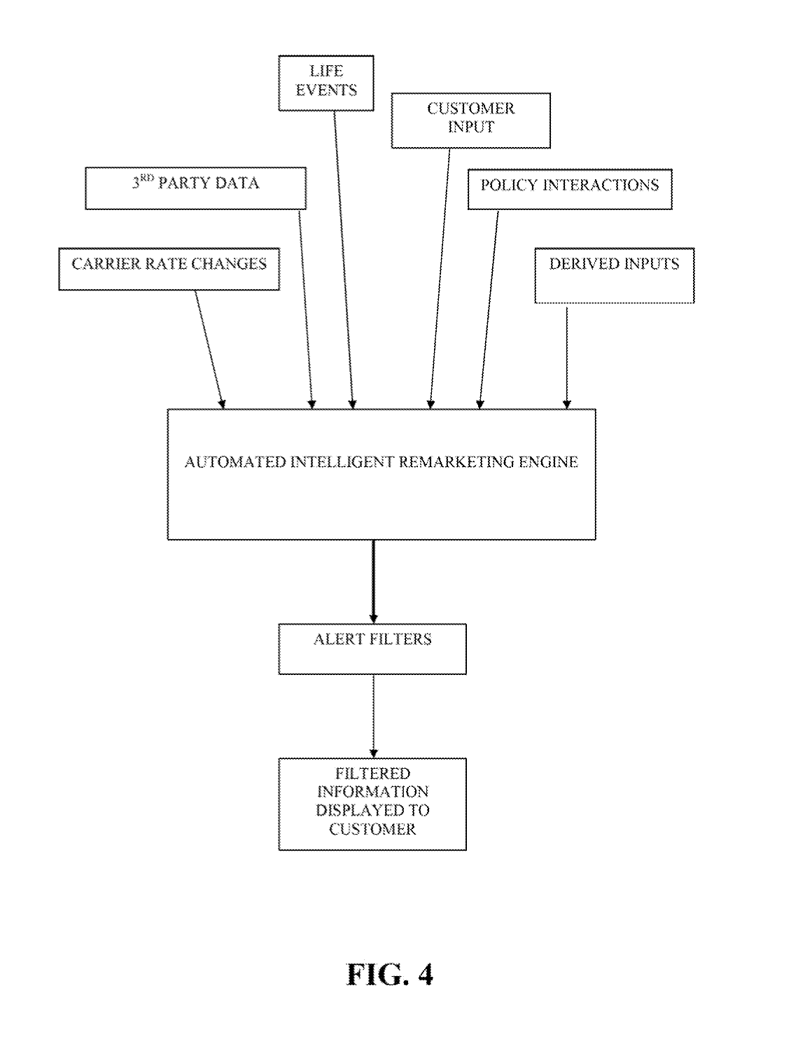

FIG. 4 shows a generalized representation of an automated re-quoting in accord with at least some aspects of the present concepts.

A re-quoting system recommendation engine is also advantageously adapted to provide real-time feedback to a customer. For example, a customer contemplating moving from the city to the suburbs may access www.realtor.com to look at one or more properties. The re-quoting system can obtain the property information from the website (e.g., through a conventional browser plug-in) and use that data to internally provide a quote to the customer via some communication means (e.g., via an on-screen display in a pop-up window, email, text message, etc.) to timely inform the customer as to the likely property insurance premium for that property.

The re-quoting system recommendation engine is also advantageously adapted to provide real-time feedback on insurance rates to a customer visiting another insurance company website. For example, a person visiting www.progressive.com entering information to obtain a price quote may have the entered data transmitted to Kemper and State Farm and corresponding quotes provided to such person contemporaneously with the quote displayed from Progressive.

The present concepts provide a consumer empowerment tool that enables customers to get the best deals possible in a manner that is convenient and timely.

While the invention is susceptible to various modifications and alternative forms, specific embodiments thereof have been shown by way of example in the drawings and herein described in detail. It should be understood, however, that it is not intended to limit the invention to the particular forms disclosed, but on the contrary, the intention is to cover all modifications, equivalents, and alternatives falling within the spirit and scope of the invention as defined by the appended claims. For example, in lieu of the acts set forth in FIG. 1, wherein responsive to one or more triggers, transmitting the insurance customer data set to one or more insurance carrier(s), via a communication device, to obtain respective insurance quote(s) (step S120) and receiving insurance quote(s), via the communication device, relating to the insurance customer data set (S130), a manufactured rating system may be employed to the same end.

The manufactured rating system allows for the rating of a particular insurance risk without the need to interact with an insurance carrier's rating system. An entity (e.g., an internet insurance agency) creates a manufactured rating system by manufacturing the rate plan for said carrier, in essence creating software including algorithms adapted to approximate said insurance carrier's rating algorithm using publicly available information. To obtain information on the carrier's rate plan, product filings are obtained from public sources such as, but not limited to, Departments of Insurance in which such product filings are lodged. The methods and systems herein can thus be utilized directly by an entity (e.g., an internet insurance agency, insurance re-quoting provider, etc.) or indirectly, via a third party service providing a manufactured rating system for one or more insurance carriers, to estimate insurance quote(s) relating to the insurance customer data set. The manufactured rating system allows for the rating of a particular insurance risk without the need to interact with an insurance carrier's rating system and permits comparison of such estimated insurance quote(s) to determine if any of the estimated insurance quote(s) satisfy one or more of the insurance re-quoting trigger(s), as in steps S140b of FIG. 1, and taking of further action(s) specified by a customer if any of the estimated insurance quote(s) satisfy one or more of the insurance re-quoting trigger(s), as in step S150 of FIG. 1.

In accord with at least some aspects of the present concepts, manufactured rates are used in an initial insurance re-quoting betterment assessment process and, if the initial insurance re-quoting betterment assessment process yields results that appear promising (e.g., within a margin of error of one or more predetermined betterment criteria, etc.), then the insurance re-quoting provider can trigger an actual insurance re-quoting operation to obtain real quotes, re-assess for betterment against one or more betterment criteria and then present the results to the consumer. Thus, the estimated or manufactured quote process is performed, analyzed and potentially utilized as an insurance re-quoting operation.

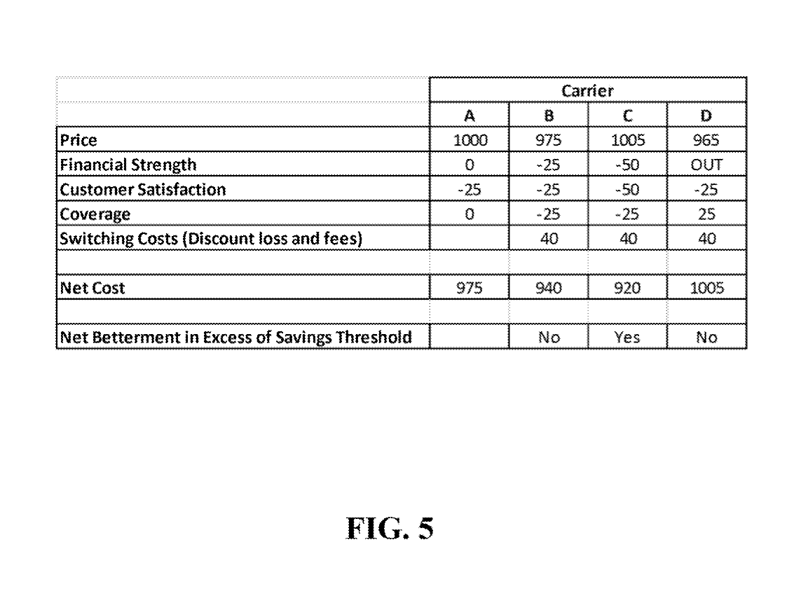

FIG. 5 shows a simple example of a betterment determination, in accord with at least some aspects of the present concepts, for a customer having an existing auto and home policy with insurance carrier A, which has a financial strength rating of A−, a customer satisfaction rating of 4 stars, and a coverage value of $0.

In this example, the auto policy with insurance carrier A has a premium of $1000 and includes a multi-policy discount and a $10 cancellation fee. The home policy with insurance carrier A has an $800 premium, includes a $30 multi-policy discount and a $5 cancellation fee. In accord with the present concepts, the customer has stated certain preferences for switching to another insurance carrier, specifying that the customer's savings threshold to switch would be S50 and that further the customer desires an insurance carrier with a financial strength rating no lower than A−. Further to these stated conditions, the system has inferred certain customer preferences based on past inputs of the customer and inputs of other customers similarly situated to the customer. As shown in FIG. 5, a variety of negative values are indicated for financial strength and customer satisfaction. In this context, the negative values indicate not that the item is of negative value, but rather that the negative number will effectively lower the net price of the policy with that associated statistic. FIG. 5 shows that, from insurance carrier A through D, the customer satisfaction ratings are scored as 5-star=−$50; 4-star=−$25; 3-star=$0, 2-star=$25; 1-star=$50 and the financial strength ratings are scored as A−=$0; A=−$25; A+=−$50.

Based on an insurance re-quoting trigger, a re-quoting operation is initiated and the following auto quotes are returned. Insurance carrier B offers a premium of $975, an A financial strength rating, a 4-star customer satisfaction rating, and −$25 in better coverage than the customer's current policy. Insurance carrier C offers a premium of $1005, an A+ financial strength rating, a 5-star customer satisfaction rating, and −$25 in better coverage than current policy. Insurance carrier D offers a premium of $965, a B+ financial strength rating, a 4-star customer satisfaction rating, and +$25 in worse coverage than current policy. Carrier C offers the best option for the customer's preferences, even though it's the highest priced. Carrier B has a lower price and a lower net cost, but does not exceed the savings threshold. Carrier D is not considered because its financial strength rating is lower than the customer minimum threshold for that characteristic.

Each of these embodiments and obvious variations thereof is contemplated as falling within the spirit and scope of the claimed invention, which is set forth in the following claims. Moreover, the present concepts expressly include any and all combinations and sub-combinations of the preceding elements and aspects and any and all combinations and sub-combinations of distinct elements of the appended claims, to the extent that such elements are not logically combinable.

Further, although the insurance re-quoting provider has been described herein in relation to an entity separate from an insurance carrier, the acts and systems herein may be conducted by an insurance carrier or representative thereof in accord with aspects of the present concepts.

Still further, although the present concepts have generally been expressed in relation to re-quoting operations conducted for persons already having existing insurance policies, the present concepts are not limited to performing re-quoting operations for persons already having existing insurance policies. Instead, in some aspects of the present concepts, targeted re-quoting operations are made available to persons who come to utilize the services of the re-quoting provider but who do not yet have insurance products or persons who do not have insurance product in the area of insurance for which they wish to enlist the insurance re-quoting provider's services. Thus, the re-quoting services may be provided in a first instance of quoting to a potential new customer and re-quoting, as used herein, encompasses such initial instances of quoting. In this manner, potential new customers can assess, through the re-quoting provider, various insurance products and/or providers. Alternatively or in addition, potential new customers can assess, through the re-quoting provider, whether or not any filed rate requests, life changes, or other factors could have an impact on their insurance purchase decision(s). Optionally, the re-quoting provider can provide such potential new customers with general data on the rates of people of one or more similar classes so the potential new customer can assess the rates and/or policy features of people like them (e.g., people like them as determined for example by statistical or AI methods).

What is claimed:

1. A computer system configured to perform automated insurance re-quoting operations, the computer comprising a communication device, at least one processor, and at least one physical storage medium, the computer system being programmed to execute instructions borne by the at least one physical storage medium to cause the computer system to perform acts comprising:
storing an insurance customer data set in the at least one physical storage medium;
storing in the at least one physical storage medium, in association with the insurance customer data set, one or more insurance re-quoting triggers and one or more betterment conditions;
conducting an insurance re-quoting operation using the at least one processor and the communication device, responsive to satisfaction of at least one of the one or more insurance re-quoting triggers, the insurance re-quoting operation comprising accessing, directly or indirectly, at least one insurance carrier quoting system to cause the at least one insurance carrier to return an insurance quote or accessing at least one third-party service to cause the at least one third-party service to return an insurance quote or an insurance quote estimate;
storing, in association with the insurance customer data set, the returned insurance quote or insurance quote estimate; and
comparing, using the at least one processor, the returned insurance quote or insurance quote estimate to determine if the returned insurance quote or insurance quote estimate satisfies at least one of the one or more betterment conditions.

2. The computer system according to claim 1, the computer system being further programmed to execute instructions borne by the at least one physical storage medium to cause the computer system to further perform acts comprising:
updating an insurance customer data set in the at least one physical storage medium.

3. The computer system according to claim 2, wherein the updating comprises receiving an update to the insurance customer data set from at least one of a customer, a 3^{rd} party data source, an insurance carrier data, or a source providing derived data.

4. The computer system according to claim 1, wherein the one or more insurance re-quoting triggers comprises at least one of a temporal trigger, an event-based trigger, or a manual trigger configured to be initiated upon a customer request.

5. The computer system according to claim 4, wherein the event-based trigger comprises one or more of a change in an insurance carrier product price coverage or term, a rating of a similar group of insured persons in the marketplace, a material change in an insurance carrier financial status, or a material change in an insurance carrier customer service metric.

6. The computer system according to claim 1, wherein the act of accessing the at least one third-party service comprises using a third-party service manufactured rating system having rating algorithms derived from insurance carrier rate filings.

7. The computer system according to claim 1, wherein the act of accessing comprises directly accessing insurance carrier quoting systems.

8. The computer system according to claim 1, wherein the act of accessing comprises directly accessing third-party service rating software.

9. The computer system according to claim 1, wherein the act of comparing, using the at least one processor, the returned insurance quote or the insurance quote estimate to determine if the returned insurance quote or the returned insurance quote estimate satisfies at least one of the one or more betterment conditions comprises assessing a betterment condition comprising a price or a cost differential, the price or the cost differential relates to at least one of an insurance premium, insurance fees, insurance discounts, loss of insurance discounts, or return premium calculations.

10. The computer system according to claim 1, wherein the act of comparing, using the at least one processor, the returned insurance quote or the returned insurance quote estimate to determine if the returned insurance quote or the returned insurance quote estimate satisfies the one or more betterment conditions, comprises comparing differences in insurance policy terms and conditions.

11. The computer system according to claim 1, wherein the act of comparing, using the at least one processor, the returned insurance quote or the returned insurance quote estimate to determine if the returned insurance quote or the returned insurance quote estimate satisfies the one or more betterment conditions, comprises comparing using the at least one processor at least one of insurance policy coverage, limits, deductibles, billing options, or policy features.

12. The computer system according to claim 1, wherein the act of comparing, using the at least one processor, the returned insurance quote to determine if the returned insurance quote or the returned insurance quote estimate satisfies the one or more betterment conditions, comprises comparing at least one characteristic of an insurance carrier.

13. The computer system according to claim 12, wherein the at least one characteristic of an insurance carrier comprises at least one of an insurance carrier financial strength metric, an insurance carrier customer satisfaction metric, an insurance carrier customer complaint metric, an insurance carrier customer loyalty metric, an insurance carrier customer claims metric, an insurance carrier customer claim service metric, an insurance carrier brand awareness metric, an insurance carrier customer retention metric, or insurance carrier sales conversion metric.

14. The computer system according to claim 1, wherein at least one of the one or more betterment conditions comprises a customer-specified betterment condition.

15. The computer system according to claim 1, further comprising:
evaluating the returned insurance quotes or insurance quote estimates satisfying a plurality of betterment conditions to determine which of the returned insurance quotes or insurance quote estimates provide a net betterment.

16. The computer system according to claim 15, further comprising, in association with the act of comparing using the at least one processor, applying weighting factors to one or more of the plurality of betterment conditions.

17. The computer system according to claim 16, wherein the weighting factors are determined by analysis of prior customer decisions, derived customer data, or third-party data relating to the customer or to a group of persons similar to the customer using methods including mathematical methods or human expert opinion.

18. The computer system according to claim 1, wherein the act of comparing the returned insurance quotes or the returned insurance quote estimates using the at least one processor to determine if returned insurance quotes or the returned insurance quote estimates satisfy the one or more betterment conditions further comprises using the at least one processor to sort the returned insurance quotes or insurance quote estimates in a ranked order.

19. The computer system according to claim 1, wherein the act of comparing the returned insurance quotes or the returned insurance quote estimates using the at least one processor to determine if returned insurance quotes or the returned insurance quote estimates satisfy the one or more betterment conditions further comprises using the at least one processor to evaluate a plurality of insurance policies in combination.

20. The computer system according to claim 1, wherein the act of comparing the returned insurance quotes or the returned insurance quote estimates using the at least one processor to determine if returned insurance quotes or the returned insurance quote estimates satisfy the one or more betterment conditions further comprises using the at least one processor to, in the absence of customer insurance policy data, assess a relative betterment as between the returned insurance quotes or the returned insurance quote estimates.
